(19) United States
(12) Patent Application Publication
(10) Pub. No.: US 2022/0236678 A1
(43) Pub. Date: Jul. 28, 2022

(54) APPLICATION DEVICE AND IMAGE FORMING APPARATUS

(71) Applicant: Hironori Numata, Ibaraki (JP)

(72) Inventor: Hironori Numata, Ibaraki (JP)

(73) Assignee: Ricoh Company, Ltd., Tokyo (JP)

(21) Appl. No.: 17/646,924

(22) Filed: Jan. 4, 2022

(30) Foreign Application Priority Data
Jan. 22, 2021 (JP) 2021-008879

(51) Int. Cl. G03G 15/20

(52) U.S. Cl. CPC G03G 15/2096

(57) ABSTRACT

An application device includes an application roller to apply a treatment liquid to a sheet medium and multiple conveyance roller pairs to convey the sheet medium from an upstream side to a downstream side of the application roller. The multiple conveyance roller pairs define a conveyance path of the sheet medium and include a downstream conveyance roller pair adjacent to the application roller on the downstream side along the conveyance path. The downstream conveyance roller pair includes two rollers having a length equal to or longer than a width of the sheet medium and a nip force applying member that applies a nip force to one of the two rollers to nip the sheet medium with the two rollers in a width direction of the sheet medium.

### CROSS-REFERENCE TO RELATED APPLICATION

This patent application is based on and claims priority pursuant to 35 U.S.C. § 119(a) to Japanese Patent Application No. 2021-008879, filed on Jan. 22, 2021, in the Japan Patent Office, the entire disclosure of which is hereby incorporated by reference herein.

### BACKGROUND

### Technical Field

Aspects of the present disclosure relate to an application device and an image forming apparatus.

### Description of the Related Art

There is known an image forming apparatus that applies liquid ink to a sheet medium to form an image. Before the liquid ink is applied to the sheet medium, an application device may apply treatment liquid having an effect of aggregating the liquid ink to the sheet medium.

### SUMMARY

Embodiments of the present disclosure describe an improved application device that includes an application roller to apply a treatment liquid to a sheet medium and multiple conveyance roller pairs to convey the sheet medium from an upstream side to a downstream side of the application roller. The multiple conveyance roller pairs define a conveyance path of the sheet medium and include a downstream conveyance roller pair adjacent to the application roller on the downstream side along the conveyance path. The downstream conveyance roller pair includes two rollers having a length equal to or longer than a width of the sheet medium and a nip force applying member that applies a nip force to one of the two rollers to nip the sheet medium with the two rollers in a width direction of the sheet medium.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating an example of a printer as embodiments of an image forming apparatus according to the present disclosure;

FIG. 2 is a schematic view illustrating a part of an application device according to embodiments of the present disclosure;

FIG. 3 is a schematic view illustrating a configuration of a downstream conveyance roller pair according to a first embodiment of the present disclosure;

FIG. 4 is a schematic view illustrating a configuration of a downstream conveyance roller pair according to a second embodiment of the present disclosure;

FIG. 5 is a block diagram illustrating a control configuration of the downstream conveyance roller pair according to the second embodiment;

FIG. 6 is a flowchart illustrating a control flow of the downstream conveyance roller pair according to the second embodiment;

FIG. 7 is a control table for the downstream conveyance roller pair according to the second embodiment;

FIG. 8 is a schematic view illustrating a configuration of a downstream conveyance roller pair according to a third embodiment of the present disclosure;

FIG. 9 is a block diagram illustrating a control configuration of the downstream conveyance roller pair according to the third embodiment;

FIG. 10 is a flowchart illustrating a control flow of the downstream conveyance roller pair according to the third embodiment;

FIG. 11 is a control table for the downstream conveyance roller pair according to the third embodiment;

FIG. 12 is a schematic view illustrating a configuration of a downstream conveyance roller pair according to a fourth embodiment of the present disclosure;

FIG. 13 is a block diagram illustrating a control configuration of the downstream conveyance roller pair according to the fourth embodiment;

FIG. 14 is a flowchart illustrating a control flow of the downstream conveyance roller pair according to the fourth embodiment; and

FIG. 15 is a control table for the downstream conveyance roller pair according to the fourth embodiment.

The accompanying drawings are intended to depict embodiments of the present disclosure and should not be interpreted to limit the scope thereof. The accompanying drawings are not to be considered as drawn to scale unless explicitly noted. In addition, identical or similar reference numerals designate identical or similar components throughout the several views.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

As used herein, the singular forms “a,” “an,” and “the” are intended to include the plural forms as well, unless the context clearly indicates otherwise.

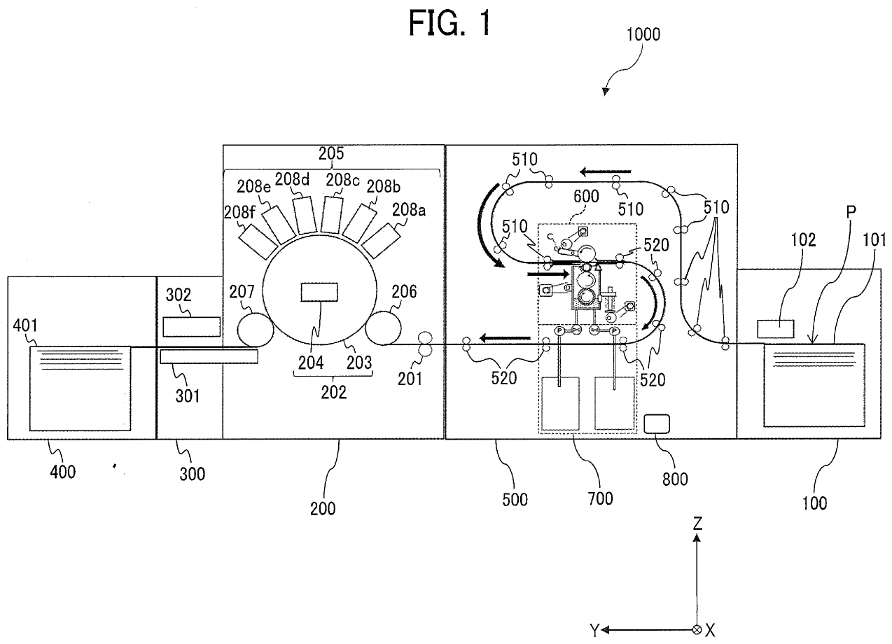

Hereinafter, embodiments of the present disclosure are described with reference to the drawings. FIG. 1 is a schematic view illustrating an overall configuration of a printer 1000 as embodiments of an image forming apparatus according to the present disclosure. The printer 1000 is, for example, an inkjet printer.

FIG. 1 illustrates the inkjet printer 1000 that discharges liquid ink onto a sheet P to form an image. The sheet P is an example of a sheet medium having a sheet shape. The printer 1000 includes a loading device 100, an application device 500, an image forming device 200, a drying device 300, and an ejection device 400. The application device 500 corresponds to embodiments of an application device according to the present disclosure.

The loading device 100 includes a sheet loading tray 101 on which a plurality of sheets P is stacked, a feeder 102 to separate and feed the sheets P one by one from the sheet loading tray 101. Any feeder having a function of separating and conveying the sheet P can be used as the feeder 102, such as a device using rollers or a device using air suction. The feeder 102 feeds the sheet P from the sheet loading tray 101 to the application device 500.

The application device 500 includes an application unit 600, multiple upstream conveyance roller pairs 510, multiple downstream conveyance roller pairs 520, a controller 800 as circuitry, and a liquid supply unit 700. The application unit 600 applies treatment liquid to the sheet P. The multiple upstream conveyance roller pairs 510 are disposed upstream from the application unit 600 and serves as conveyors to convey the sheet P to the application unit 600. The multiple downstream conveyance roller pairs 520 are disposed downstream from the application unit 600 and serves as conveyors to convey the sheet P to the image forming device 200. The liquid supply unit 700 supplies the treatment liquid to the application unit 600. The feeder 102 coveys the sheet P to the application device 500, and the multiple upstream conveyance roller pairs 510 convey the sheet P to the application unit 600. The application unit 600 applies the treatment liquid to the sheet P. The multiple downstream conveyance roller pairs 520 forward the sheet P to which the treatment liquid has been applied to the image forming device 200.

The image forming device 200 includes a registration roller pair 201, a sheet conveyor 202, a liquid discharger 205, an upstream transfer cylinder 206, and a downstream transfer cylinder 207. After the sheet P fed from the application device 500 reaches the registration roller pair 201, the registration roller pair 201 feeds the sheet P to the sheet conveyor 202 at a predetermined timing.

The sheet conveyor 202 includes a drum 203 and a suction device 204. The drum 203 rotates while bearing the sheet P on an outer circumferential surface thereof. The suction device 204 generates a suction force on the outer circumferential surface of the drum 203 to bear the sheet P. With this configuration, the sheet P is conveyed while being sucked to the outer circumferential surface of the drum 203 and passes through the liquid discharger 205.

The upstream transfer cylinder 206 is disposed upstream from the drum 203. The upstream transfer cylinder 206 receives the sheet P fed from the registration roller pair 201 and transfers the sheet P to the drum 203. The downstream transfer cylinder 207 is disposed downstream from the drum 203. The downstream transfer cylinder 207 receives the sheet P conveyed by the drum 203 and transfers the sheet P to the drying device 300.

The registration roller pair 201 feeds the sheet P to the upstream transfer cylinder 206 at a predetermined timing, and a gripper of the upstream transfer cylinder 206 grips the leading end of the sheet P. The upstream transfer cylinder 206 rotates while gripping the sheet P to convey the sheet P to a position facing the drum 203, and transfers the sheet P to the drum 203.

A gripper is also provided on the surface of the drum 203. The drum 203 receives the sheet P gripped and conveyed by the upstream transfer cylinder 206 and grips the sheet P with the gripper. The drum 203 has a plurality of suction holes dispersedly on the surface thereof, and the suction device 204 generates suction airflows directed inward from desired suction holes of the drum 203. The gripper of the drum 203 grips the leading end of the sheet P transferred from the upstream transfer cylinder 206, and the suction device 204 sucks the sheet P on the drum 203 with the suction airflows. As the drum 203 rotates, the sheet P is conveyed.

The liquid discharger 205 includes discharge units 208a to 208f that discharge and apply liquids of different colors toward the sheet P which is borne and conveyed by the drum 203. Hereinafter, the discharge units 208a to 208f are also collectively referred to as “discharge units 208,” and one of the discharge units 208a to 208f is referred to as a “discharge unit 208” unless distinguished. For example, the discharge unit 208a discharges liquid of black (K), the discharge unit 208b discharges liquid of cyan (C), the discharge unit 208c discharges liquid of magenta (M), and the discharge unit 208d discharges liquid of yellow (Y).

Further, the discharge units 208e and 208f are used to discharge the liquid of any one of Y, M, C, and K or liquid of spot color such as white, gold, or silver. Furthermore, a discharge unit 208 that discharges treatment liquid such as surface coating liquid may be provided. The discharge unit 208 is a full line head including a plurality of liquid discharge heads. Each liquid discharge head includes nozzle rows including a plurality of nozzles.

A discharge operation of each of the discharge units 208 of the liquid discharger 205 is controlled by a drive signal corresponding to image formation data for image forming process. When the sheet P borne on the drum 203 passes through a region facing the liquid discharger 205, the discharge units 208 perform the discharge operation to discharge the respective color liquids to the sheet P. By this discharge operation, an image corresponding to the image formation data is printed on the sheet P.

That is, liquid is applied to the sheet P by the liquid discharger 205 in the image forming process. The sheet P to which the liquid has been applied is delivered from the surface of the drum 203 to the downstream transfer cylinder 207. Similarly, the downstream transfer cylinder 207 includes a gripper on the surface thereof to grip the leading end of the sheet P. After released from the gripper of the drum 203, the leading end of the sheet P is gripped by the gripper of the downstream transfer cylinder 207, thereby transferring the sheet P from the drum 203 to the downstream transfer cylinder 207. Then, the sheet P is fed to the drying device 300 via the circumferential surface of the downstream transfer cylinder 207 as the downstream transfer cylinder 207 rotates.

The drying device 300 includes a suction conveyor 301 and a dryer 302. The suction conveyor 301 conveys the sheet P while sucking the sheet P transferred from the downstream transfer cylinder 207 of the image forming device 200. The dryer 302 dries the liquid on the sheet P conveyed by the suction conveyor 301.

The ejection device 400 includes an output tray 401 on which a plurality of sheets P is stacked. The sheets P conveyed from the drying device 300 are sequentially stacked and held on the output tray 401.

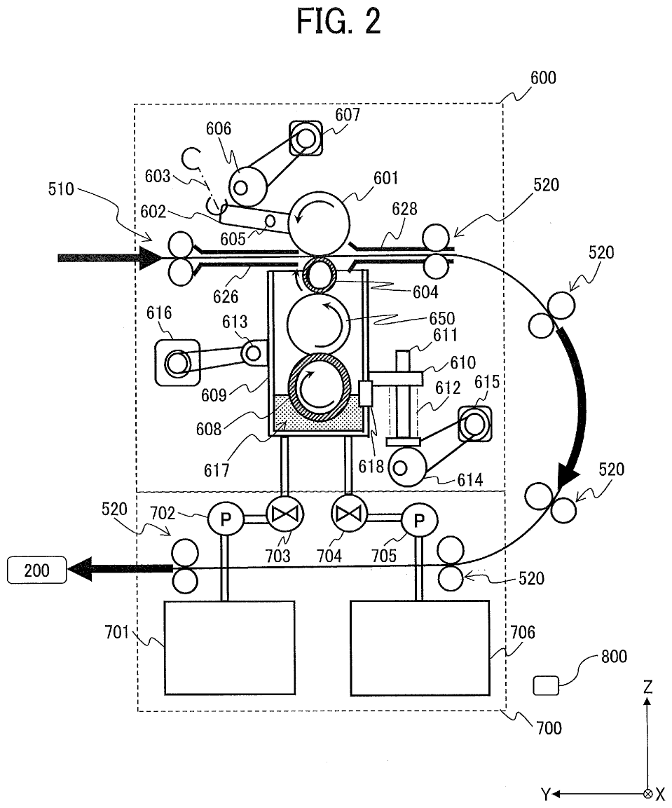

Next, a description is given of the application device 500 according to a first embodiment of the present disclosure. FIG. 2 is a schematic view illustrating an overall configuration of an application unit 600 included in the application device 500. The application unit 600 is a part of the application device 500 and includes a transfer roller 601, an application roller 604, a metering roller 650, and a draw-up roller 608 as illustrated in FIG. 2.

The transfer roller 601 is rotatably supported at one end of an arm 602. A spring 603 is coupled to the other end of the arm 602. The arm 602 is supported by an arm rotation shaft 605 at an intermediate position of the arm 602 and swingable around the arm rotation shaft 605 as a rotation center. The spring 603 pulls the arm 602 by a tensile force so as to swing the arm 602 around the arm rotation shaft 605, thereby pressing the transfer roller 601 against the application roller 604.

A cam 606 contacts the arm 602. As the cam 606 rotates, the cam 606 biases the arm 602 against the tensile force of the spring 603 so that the transfer roller 601 can be moved in a direction away from the application roller 604. A cam motor 607 is driven to rotate the cam 606. Therefore, the cam motor 607 is controlled so as to adjust a contact force between the transfer roller 601 and the application roller 604 to adjust the amount of treatment liquid applied to the sheet P.

The draw-up roller 608 is elastically pressed against the metering roller 650, and the metering roller 650 is elastically pressed against the application roller 604. The draw-up roller 608 is rotatably supported by a side plate of the application unit 600. Further, the draw-up roller 608 is movably supported by the side plate of the application unit 600 in a direction toward or away from the transfer roller 601.

Specifically, the draw-up roller 608 is rotatably supported by the side plate of a supply liquid chamber 609 of the application unit 600. The supply liquid chamber 609 is swingably supported by a fulcrum 613. An arm 610 is provided on the side plate of the supply liquid chamber 609. The arm 610 is biased by a compression spring 612 via a pin 611. The draw-up roller 608 is pressed against the metering roller 650 by a biasing force of the compression spring 612, and thus the metering roller 650 is elastically pressed against the application roller 604.

The liquid chamber cam 614 contacts the pin 611. As the liquid chamber cam 614 rotates, the pin 611 moves in the vertical direction. As the pin 611 moves, the degree of compression of the compression spring 612 is changed. The supply liquid chamber 609 is moved along the pin 611 in response to the biasing force generated by the degree of compression of the compression spring 612. As a result, the nip load between the application roller 604 and the metering roller 650 and the nip load between the metering roller 650 and the draw-up roller 608 are changed. The liquid chamber cam motor 615 is driven to rotate the liquid chamber cam 614.

Further, the transfer roller 601, the application roller 604, the metering roller 650, and the draw-up roller 608 are coupled by gears, and rotationally driven by an application motor 616. Alternatively, the transfer roller 601, the application roller 604, the metering roller 650, and the draw-up roller 608 may be rotated by being elastically pressed against each other.

The supply liquid chamber 609 contains aggregation liquid 617 as treatment liquid. The draw-up roller 608 is immersed in the aggregation liquid 617. Therefore, as the draw-up roller 608 rotates, the aggregation liquid 617 adheres to the outer circumferential surface of the draw-up roller 608 and is scooped up. A liquid level sensor 618 is attached to the supply liquid chamber 609 to detect the liquid level of the aggregation liquid 617. The controller 800 monitors the output of the liquid level sensor 618 to adjust the position (height) at which the draw-up roller 608 is immersed in the aggregation liquid 617.

As the aggregation liquid 617 is applied to the sheet P, the aggregation liquid 617 is consumed and the liquid level of the aggregation liquid 617 in the supply liquid chamber 609 is lowered. As the liquid level sensor 618 detects that the liquid level of the aggregation liquid 617 is lower than a predetermined threshold, a supply valve 703 is opened and a supply pump 702 is driven. As the supply pump 702 is driven, the aggregation liquid 617 in a supply tank 701 is fed to the supply liquid chamber 609. Thus, the aggregation liquid 617 is replenished to be consumed for applying to the sheet P by the application roller 604. When the liquid level reaches a predetermined level, the supply valve 703 is closed and the supply pump 702 is stopped. Thus, the liquid level of the aggregation liquid 617 in the supply liquid chamber 609 can be kept constant.

The aggregation liquid 617 may deteriorate over time, for example, the viscosity increases depending on the storage time. It is not preferable to use the deteriorated aggregation liquid 617 for applying to the sheet P because the deteriorated aggregation liquid 617 may not exhibit a predetermined performance to aggregate the liquid ink on an image forming surface of the sheet P. Therefore, the aggregation liquid 617 that may have deteriorated to a certain extent over time is drained from the supply liquid chamber 609 and is not used for applying to the sheet P. The liquid supply unit 700 includes a drain valve 704, a drain pump 705, and a waste liquid tank 706 to drain the aggregation liquid 617 from the supply liquid chamber 609. As the drain valve 704 is opened and the drain pump 705 is driven, the aggregation liquid 617 in the supply liquid chamber 609 is drained into the waste liquid tank 706.

Next, a description is given of a flow of applying the aggregation liquid 617 to the sheet P. In the application unit 600 having the above-described configuration, the aggregation liquid 617 in the supply liquid chamber 609 is scooped up as the draw-up roller 608 rotates. The aggregation liquid 617 scooped up by the draw-up roller 608 is transported to a contact position between the draw-up roller 608 and the metering roller 650. As the aggregation liquid 617 passes through the contact position (nip), the amount of the aggregation liquid 617 is adjusted, and the adjusted aggregation liquid 617 is transferred to the surface of the metering roller 650.

The aggregation liquid 617 transferred to the surface of the metering roller 650 is transported to a contact position (nip) between the metering roller 650 and the application roller 604. As the aggregation liquid 617 passes through the contact position (nip) between the metering roller 650 and the application roller 604, the aggregation liquid 617, which is a thin layer, is transferred to the surface of the application roller 604. The thin layer of the aggregation liquid 617 formed on the surface of the application roller 604 is transported to a contact position (nip) between the application roller 604 and the transfer roller 601, comes into contact with the sheet P, and is transferred to the image forming surface of the sheet P. Thus, the aggregation liquid 617 is applied to the sheet P.

The upstream conveyance roller pair 510 is disposed upstream from the application roller 604 in the conveyance direction of the sheet P and feeds the sheet P to the contact position between the application roller 604 and the transfer roller 601. An upstream guide plate pair 626 is disposed on a path from the upstream conveyance roller pair 510 to the contact position (nip) between the application roller 604 and the transfer roller 601. The sheet P conveyed by the multiple upstream conveyance roller pairs 510 passes through the upstream guide plate pair 626 and is conveyed to the contact position between the application roller 604 and the transfer roller 601. As the sheet P passes through the contact position between the application roller 604 and the transfer roller 601, the aggregation liquid 617 is applied to the sheet P, and then the sheet P is conveyed downstream. In this case, the surface of the sheet P that the application roller 604 contacts is an application surface of the aggregation liquid 617. In a downstream process, an image is formed on the application surface, that is, the image forming surface.

The downstream conveyance roller pair 520 is disposed downstream from the application roller 604 to convey the sheet P immediately after being coated with the aggregation liquid 617 to the downstream side. Further, a downstream guide plate pair 628 is disposed downstream from the application roller 604 to guide the sheet P to the downstream conveyance roller pair 520.

As illustrated in FIG. 2, the multiple downstream conveyance roller pairs 520 are disposed downstream from the application roller 604 and define a conveyance path to the image forming device 200. One of the multiple downstream conveyance roller pairs 520 that is disposed adjacent to the application roller 604 on the downstream side of the application roller 604 has a length equal to or longer than the width of the sheet P to cover the full width of the sheet P. In other words, the downstream conveyance roller pair 520 includes two rollers that nip the sheet P next to the transfer roller 601 and the application roller 604 have a contact face that can contact the full width of the sheet P. Note that all of the downstream conveyance roller pairs 520 disposed downstream from the application roller 604 may have the configuration according to each embodiment described below.

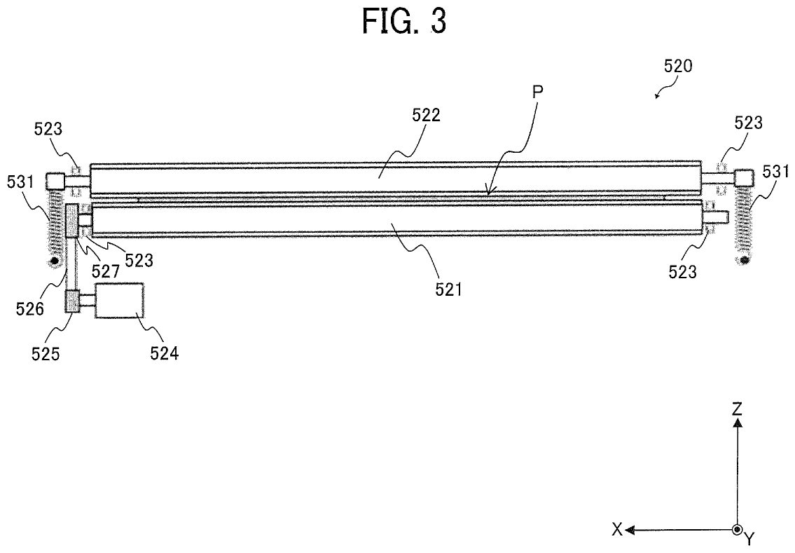

FIG. 3 is a schematic view of the downstream conveyance roller pair 520 as viewed in the conveyance direction of the sheet P. The downstream conveyance roller pair 520 includes the two rollers that are longer than the width of the sheet P in a width direction of the sheet P (i.e., along the X-axis) perpendicular to the conveyance direction of the sheet P (i.e., along the Y-axis). The downstream conveyance roller pair 520 covers the full width of the sheet P, and has the contact face that evenly contacts the full width of the sheet P when the sheet P is nipped.

As described above, the downstream conveyance roller pair 520 includes the two rollers, that is, a lower roller 521 as a drive roller and an upper roller 522 as a driven roller. Bearings 523 are disposed at both ends of each of the lower roller 521 and the upper roller 522 to rotatably support the lower roller 521 and the upper roller 522.

A pulley 527 is attached to one end of the rotation shaft of the lower roller 521. The pulley 527 is coupled to a motor pulley 525 via a belt 526. The motor pulley 525 is attached to a rotation shaft of a conveyance motor 524. Therefore, the rotation of the conveyance motor 524 is controlled to rotate the lower roller 521.

Tension springs 531 are attached to both ends of the rotation shaft of the upper roller 522 as a driven roller. The bearing 523 that rotatably supports the upper roller 522 is held in a vertically slotted hole provided in a frame of the application device 500. Therefore, the upper roller 522 is movable in the vertical direction by a biasing force of the tension spring 531 applied to the rotation shaft of upper roller 522. The tension spring 531 functions as a biasing member that biases the upper roller 522 toward the lower roller 521, and also functions as a nip force applying member that applies a force (nip force) to nip the sheet P between the upper roller 522 and the lower roller 521. With this configuration, the sheet P is nipped by the upper roller 522 and the lower roller 521.

A nip as a contact portion between the upper roller 522 and the lower roller 521 to nip the sheet P covers the full width of the sheet P. When the sheet P passes through the nip, the lower roller 521, which is a drive roller, rotates to transmit a conveyance force to the sheet P, thereby conveying the sheet P downstream in the conveyance direction. At that time, the upper roller 522 is driven to rotate by frictional force with the sheet P.

The conveyance path of the sheet P is formed such that the center of the downstream conveyance roller pair 520 in the longitudinal direction and the center of the sheet P in the width direction coincide with each other. That is, the sheet P is evenly positioned in the width direction with respect to the center of the conveyance path and conveyed in the conveyance path.

The downstream conveyance roller pair 520 described above is in line contact with the full width of the sheet P, not in point contact, and thus transmits the conveyance force to the sheet P by line contact. Therefore, the downstream conveyance roller pair 520 conveys the sheet P while evenly contacting the sheet P.

That is, the downstream conveyance roller pair 520 as a conveyor evenly contacts the entire application surface, to which the aggregation liquid 617 has been applied, of the sheet P in the width direction with a suitable force by the tension spring 531 as the nip force applying member. With this configuration, the application surface can be prevented from being partially rubbed by the conveyor (i.e., the downstream conveyance roller pair 520). As a result, image unevenness by rubbing the application surface can be prevented. In a comparative example, a conveyor is in point contact with the sheet P to convey the sheet P and may partially rub the application surface of the sheet P, causing image unevenness.

The conveyance motor 524 may be any motor that can generate the conveyance force to convey the sheet P with the downstream conveyance roller pair 520. For example, a direct current (DC) brushless motor or a stepping motor can be used as the conveyance motor 524. Each of the lower roller 521 and the upper roller 522 includes an elastic material. Any material may be used as long as the material does not damage the sheet P when the sheet P is nipped, for example, rubber, resin, or the like may be used. In particular, the lower roller 521 as the drive roller preferably includes rubber.

Next, a description is given of the application device 500 according to a second embodiment of the present disclosure. The second embodiment is different from the first embodiment in the configuration of the conveyance roller pair disposed downstream from the application roller 604 included in the application device 500. Hereinafter, different points are described in detail.

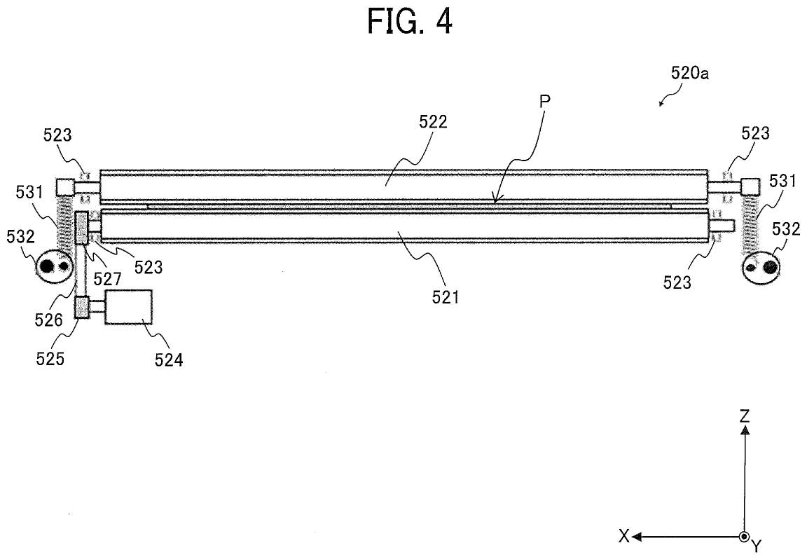

A downstream conveyance roller pair 520a according to the second embodiment is described with reference to FIG. 4. FIG. 4 is a schematic view of the downstream conveyance roller pair 520a as viewed in the conveyance direction of the sheet P. In the following description, the same components as those of the downstream conveyance roller pair 520 described in the first embodiment are denoted by the same reference numerals, and detailed descriptions thereof are omitted. The different portions in the second embodiment are described in detail. All of the conveyance roller pairs disposed downstream from the application roller 604 may have the same configuration as that of the downstream conveyance roller pair 520a described below.

At both ends of the downstream conveyance roller pair 520a, a first end of the tension spring 531 is secured to the end of the rotation shaft of the upper roller 522 as a driven roller, and a second end of the tension spring 531 is secured to a plate cam 532 serving as a nip force changer. Therefore, as the plate cam 532 rotates, the position of the second end of the tension spring 531 is changed. As a result, a tensile force of the tension spring 531 is changed, thereby changing the nip force by the tension spring 531.

The nip force is set by the tensile force of the tension spring 531 as the nip force applying member. The plate cam 532 as the nip force changer rotates to a predetermined rotation angle to determine the nip force. That is, the tension spring 531 and the plate cam 532 construct the nip force applying member. The rotation of the plate cam 532 may be controlled by a motor or the like.

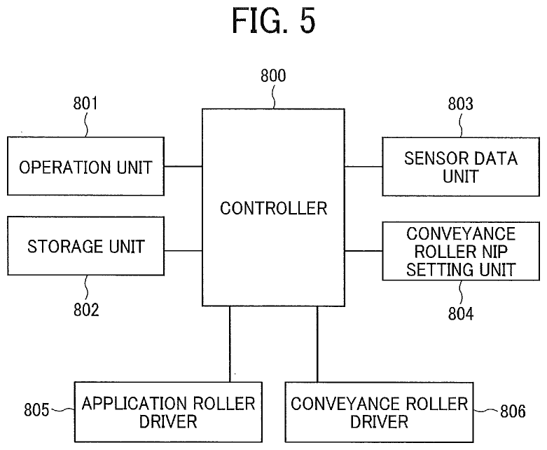

FIG. 5 is a block diagram illustrating a functional configuration of a control unit that controls the nip force of the downstream conveyance roller pair 520a according to the present embodiment. The control unit according to the present embodiment includes the controller 800, an operation unit 801, a storage unit 802, a sensor data unit 803, a conveyance roller nip setting unit 804, an application roller driver 805, and a conveyance roller driver 806.

The controller 800 includes a central processing unit (CPU), a read only memory (ROM), a random access memory (RAM), and the like. The CPU executes a predetermined control program. The ROM stores the control program. The RAM functions as a work area for arithmetic processing of the CPU. The controller 800 executes the control program to controls the operations of the other units. That is, the controller 800 comprehensively controls the entire operation of the application device 500.

The operation unit 801 receives input data from an input interface such as a touch panel on an outer surface or a top surface of a housing of the application device 500, and transmits the input data to the controller 800. Further, the operation unit 801 functions as a notification unit to display a processing result of the controller 800 and indicate an operation state of the application device 500 to a user. The user can set sheet characteristic data indicating characteristics of the sheet P such as the brand, type, basis weight, and thickness of the sheet P in the controller 800 with the operation unit 801. The user can also set an amount (i.e., application amount) of the aggregation liquid 617 to be applied to the sheet P in the controller 800 with the operation unit 801.

Note that the function corresponding to the operation unit 801 may be implemented by a control panel of the printer 1000. In this case, the user sets the sheet characteristic data and the application amount with the control panel of the printer 1000, and the data set by the user is transmitted to the controller 800. Alternatively, the user may set the data via an operation screen of an instruction terminal (for example, a computer) connected to the printer 1000.

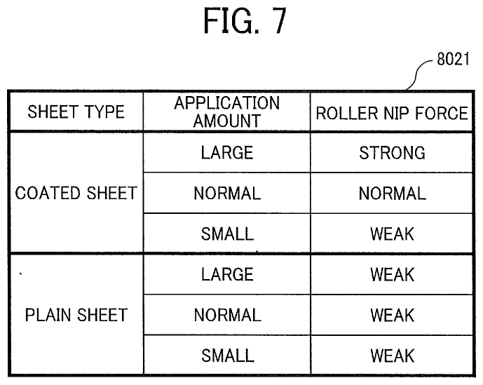

The storage unit 802 stores table data including roller nip force data. In the table data, the roller nip force data is associated with the application amount to be set for each of the sheet characteristic data (e.g., multiple sheet types). FIG. 7 illustrates a nip force setting table 8021 as an example of the table data stored in the storage unit 802. The nip force setting table 8021 stores a correlation between the application amount and the roller nip force data.

As illustrated in FIG. 7, the nip force setting table 8021 is an example of the table data that stores the roller nip force data in association with the sheet type and the application amount of the aggregation liquid 617. Accordingly, the roller nip force data can be selected based on the sheet type and the application amount. A suitable application amount is measured in advance for each sheet type included in the sheet characteristic data, and the suitable application amount (a reference value of an appropriate application amount for the sheet type) corresponds to the application amount “normal.” An appropriate nip force corresponding to the application amount “normal” is defined as the roller nip force “normal.”

When the user sets the sheet type to a “coated sheet” and sets the application amount of the aggregation liquid 617 to “large” with the operation unit 801, the plate cam 532 is rotated so that the downstream conveyance roller pair 520a applies the roller nip force corresponding to “strong.” The roller nip force “strong” is determined relative to the roller nip force “normal,” and the degree of “strong” may be determined based on a parameter defined in advance, or data for obtaining a force stronger than the roller nip force “normal” may be separately stored.

The sensor data unit 803 acquires output values of various sensors such as a sheet detection sensor that detects the conveyance state of the sheet P and the liquid level sensor 618 that detects the liquid level of the aggregation liquid 617, and transmits the output values to the controller 800. The controller 800 detects the position of the sheet P conveyed based on sensor data and controls the operations of the upstream conveyance roller pair 510, the downstream conveyance roller pair 520a, the application motor 616, and the liquid chamber cam motor 615.

The conveyance roller nip setting unit 804 controls the rotation angle of the plate cam 532 based on the roller nip force data transmitted to the controller 800, thereby setting the tensile force of the tension spring 531 that presses the upper roller 522 against the lower roller 521. By this control, the nip force in the downstream conveyance roller pair 520a is set to a predetermined magnitude. The application roller driver 805 causes the application motor 616 to rotate at a predetermined rotation speed based on a command from the controller 800. The conveyance roller driver 806 causes the conveyance motor 524 to rotate at a predetermined rotation speed based on a command from the controller 800. Thus, the conveyance speed of the sheet P is controlled.

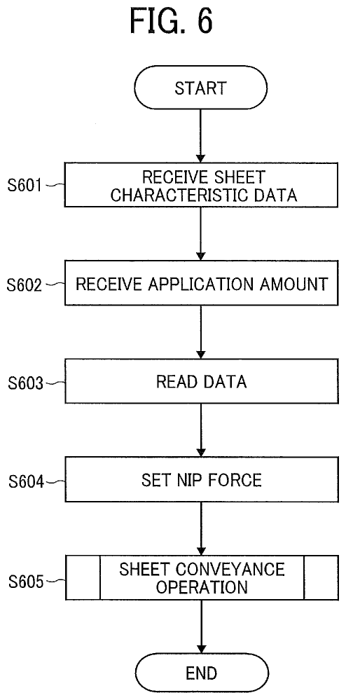

Next, a control flow in the controller 800 according to the present embodiment is described with reference to a flowchart in FIG. 6. First, a user of the application device 500 sets the “sheet type” with the operation unit 801 to designate the type of the sheet P. The controller 800 receives the “sheet type” from the operation unit 801 (S601). Then, the user sets the “application amount” with the operation unit 801 to designate the amount of the aggregation liquid 617 to be applied to the sheet P. The controller 800 receives the “application amount” from the operation unit 801 (S602). Subsequently, based on the “sheet type” and the “application amount” set by the user, the controller 800 reads the “roller nip force” stored in the nip force setting table 8021 from the storage unit 802 (S603).

Based on the “roller nip force,” the controller 800 instructs the conveyance roller nip setting unit 804 to set the nip force of the downstream conveyance roller pair 520a to a predetermined value. The conveyance roller nip setting unit 804 causes the plate cam 532 to rotate and stop at the position where the instructed nip force is obtained (S604). After that, the controller 800 causes the conveyance roller driver 806 to rotate the upstream conveyance roller pair 510 and the downstream conveyance roller pair 520a and causes the application roller driver 805 to rotate the application roller 604, thereby conveying the sheet P (S605).

A description is given of the control of the nip force (roller nip force) of the downstream conveyance roller pair 520a controlled in the above-described processing flow. For example, when the sheet P is the coated sheet, the aggregation liquid 617 is less likely to permeate into the sheet P, remains on the surface of the sheet P, and thus is more likely to be rubbed, thereby significantly affecting the change in the frictional resistance of the surface of the sheet P and also affecting the conveyance performance of the sheet P. When the application amount is set to “large,” the conveyance performance is affected particularly on the downstream side. Therefore, the roller nip force of the downstream conveyance roller pair 520a is set to “strong.”

Even when the sheet type is the “coated sheet,” the roller nip force is set to “normal” in the case of the application amount “normal” of the aggregation liquid 617. Here, the roller nip force “normal” is designated suitable for the application amount “normal” in advance. Further, even when the sheet type is the “coated sheet,” a predetermined conveyance state can be obtained in the case of the application amount “small” of the aggregation liquid 617. Therefore, the roller nip force is set to “weak,” which is weaker than the roller nip force “normal” designated suitable for the application amount “normal” in advance.

In the present embodiment, when the sheet type is a “plain sheet,” the aggregation liquid 617 is likely to permeate into the sheet P, thereby less affecting the frictional resistance of the surface of the sheet P. Therefore, in the case of the “plain sheet,” the roller nip force of the downstream conveyance roller pair 520a is set to “weak” regardless of the application amount. Thus, the roller nip force is set corresponding to the application amount for each of the sheet types (i.e., the characteristic of the sheet P) to keep the conveyance performance stable.

As described above, when the sheet P is the “coated sheet” in the application device 500, the roller nip force on the downstream side is set to “strong” in the case of the application amount “large” of the aggregation liquid 617 to prevent slip (speed unevenness) of the sheet P during conveyance. As a result, since the slip (speed unevenness) of the sheet P is prevented, the sheet P is prevented from being rubbed by the downstream conveyance roller pair 520a, thereby suppressing the change in surface properties of the sheet P and preventing image unevenness due to a difference in aggregation properties of the liquid ink due to the change in the surface properties.

In the case of the application amount “small” of the aggregation liquid 617 even when the sheet type is the “coated sheet”, or when the sheet type is the “plain sheet,” the roller nip force is set to “weak.” Accordingly, the grip between the application surface of the sheet P and the lower roller 521 can be prevented from being excessively strong. As a result, when an external force, which disturbs the conveyance state of the sheet P, due to a roller shape, a conveyance skew, or the like is applied to the sheet P, the external force can be released in the width direction of the sheet P, thereby preventing the sheet P from wrinkling.

In the present embodiment, the application amount of the aggregation liquid 617 is controlled in three levels of “large,” “normal,” and “small.” However, the number of the levels is not limited to three, and for example, the application amount may be controlled in two levels of “large” and “small” or in four or more levels. The roller nip forces “strong,” “normal,” and “weak” are parameters determined based on the application amount of the aggregation liquid 617 for each of the sheet types. The application amount is a parameter that is determined based on evaluation of a result of actually applying the aggregation liquid 617 to the sheet P in advance. The application amount “normal” is the reference value.

As described above, with the downstream conveyance roller pair 520a, the roller nip force of the sheet P can be appropriately set based on the type of the sheet P and the application amount of the aggregation liquid 617, thereby preventing the slip (speed unevenness) of the sheet P during conveyance and wrinkles of the sheet P. As a result, image unevenness can be prevented.

Next, a description is given of the application device 500 according to a third embodiment of the present disclosure. The third embodiment is different from the first and second embodiments in that one of the pair of rollers includes a heater that heats the sheet P to accelerate drying of the aggregation liquid 617 on the surface of the sheet P. Hereinafter, different points are described in detail.

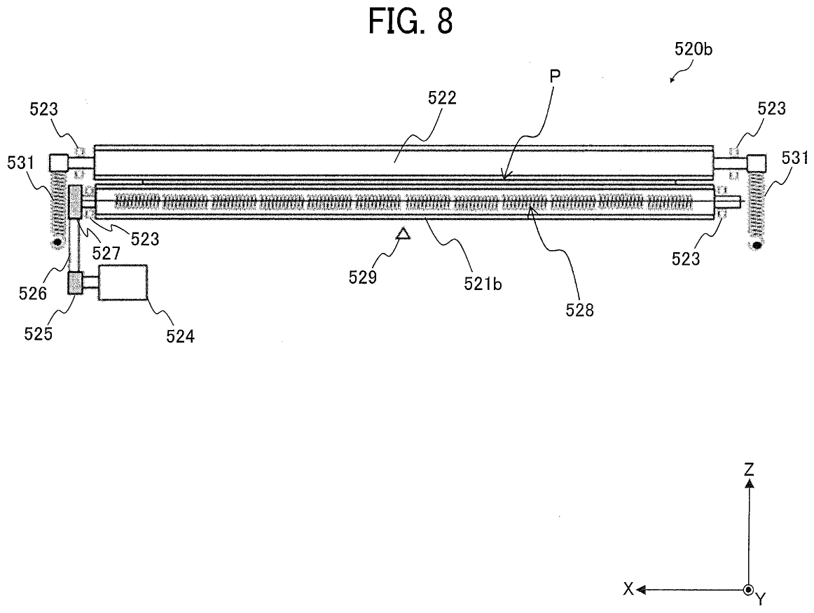

A downstream conveyance roller pair 520b according to the third embodiment is described with reference to FIG. 8. FIG. 8 is a schematic view of the downstream conveyance roller pair 520b as viewed in the conveyance direction of the sheet P. Also in the following description, the same components as those of the downstream conveyance roller pair 520 described in the first embodiment are denoted by the same reference numerals, and detailed descriptions thereof are omitted. The different portions in the third embodiment are described in detail. All of the conveyance roller pairs disposed downstream from the application roller 604 may have the same configuration as that of the downstream conveyance roller pair 520b described below.

The downstream conveyance roller pair 520b includes a roller heater 528 as a heater inside a lower roller 521b as a drive roller. A temperature sensor 529 that measures the temperature of surface of the lower roller 521b is disposed near the longitudinal center of the lower roller 521b. The roller heater 528 may be any types of heater, for example, a halogen heater that can adjust the temperature of the surface of the lower roller 521b from the inside of the lower roller 521b.

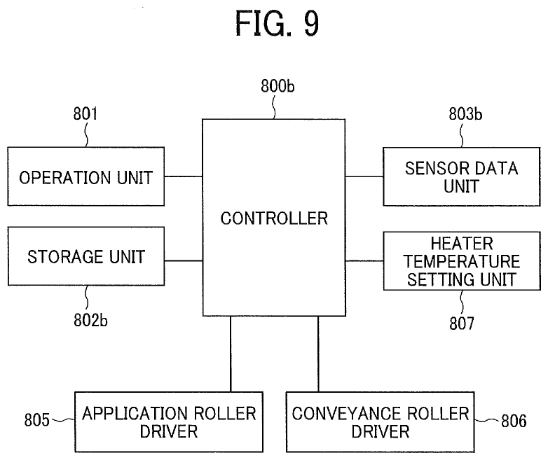

FIG. 9 is a block diagram illustrating a functional configuration of a control unit that controls the temperature of the downstream conveyance roller pair 520b according to the present embodiment. The control unit according to the present embodiment includes a controller 800b, the operation unit 801, a storage unit 802b, a sensor data unit 803b, a heater temperature setting unit 807, the application roller driver 805, and the conveyance roller driver 806. The operation unit 801, the application roller driver 805, and the conveyance roller driver 806 have the same configurations as those described above, and thus detailed descriptions thereof are omitted.

The controller 800b includes the CPU, the ROM, the RAM, and the like. The CPU executes a predetermined control program. The ROM stores the control program. The RAM functions as the work area for arithmetic processing of the CPU. The controller 800b executes the control program to controls the operations of the other units. That is, the controller 800b comprehensively controls the entire operation of the application device 500.

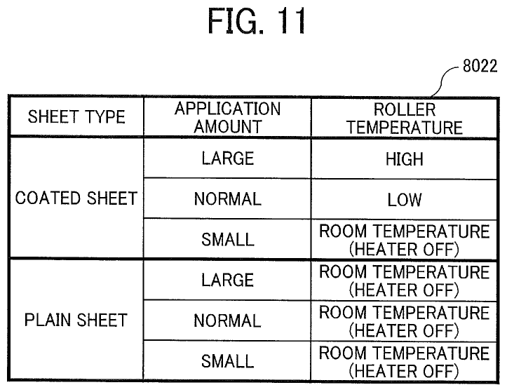

The storage unit 802b stores table data including roller temperature setting data. In the table data, the roller temperature setting data is associated with the application amount to be set for each of the sheet characteristic data (e.g., sheet types). FIG. 11 illustrates a roller temperature setting table 8022 as an example of the table data stored in the storage unit 802b. The roller temperature setting table 8022 stores a correlation between the application amount and the roller temperature setting data.

As illustrated in FIG. 11, the roller temperature setting table 8022 is an example of the table data that stores the roller temperature setting data in association with the sheet type and the application amount of the aggregation liquid 617 to control the temperature of the surface of the lower roller 521b at a predetermined temperature. A suitable application amount is measured in advance for each sheet type included in the sheet characteristic data, and the suitable application amount (the reference value of the appropriate application amount for the sheet type) corresponds to the application amount “normal.” A roller temperature suitable for the application amount “normal” is set based on the sheet type as a reference, and the other settings related to the application amount are determined based on the reference in advance.

When the user sets the sheet type to the “coated sheet” and sets the application amount of the aggregation liquid 617 to “large” with the operation unit 801, the heater temperature setting unit 807 controls the temperature of the roller heater 528 so as to maintain the surface temperature of the lower roller 521b at the temperature corresponding to the roller temperature “high.”

The sensor data unit 803b acquires output values of various sensors such as the temperature sensor 529 besides the sheet detection sensor that detects the conveyance state of the sheet P and the liquid level sensor 618 that detects the liquid level of the aggregation liquid 617, and transmits the output values to the controller 800b. The controller 800b transmits the roller temperature setting data of the roller heater 528 to the heater temperature setting unit 807 based on the output value from the temperature sensor 529. The heater temperature setting unit 807 controls the duty of the roller heater 528 based on the roller temperature setting data transmitted from the controller 800b so as to control the surface of the lower roller 521b at a predetermined temperature.

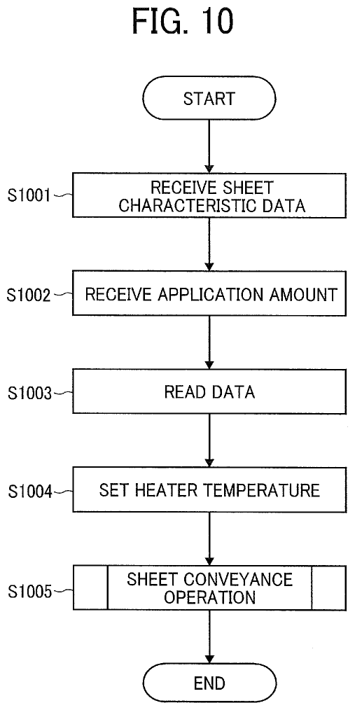

Next, a control flow in the controller 800b according to the present embodiment is described with reference to a flowchart in FIG. 10. First, a user of the application device 500 sets the “sheet type” with the operation unit 801 to designate the type of the sheet P.

The controller 800b receives the “sheet type” from the operation unit 801 (S1001). Then, the user sets the “application amount” with the operation unit 801 to designate the amount of the aggregation liquid 617 to be applied to the sheet P. The controller 800b receives the “application amount” from the operation unit 801 (S1002). Subsequently, based on the “sheet type” and the “application amount” set by the user, the controller 800 reads the “roller temperature” stored in the roller temperature setting table 8022 from the storage unit 802 (S1003).

The controller 800b controls the heater temperature setting unit 807 based on the “roller temperature” read from the storage unit 802 so that the surface temperature of the lower roller 521b becomes a predetermined temperature. The heater temperature setting unit 807 controls the duty of the roller heater 528 while referring to the output value of the sensor data unit 803b, and controls the surface temperature of the lower roller 521b (S1004). After that, the controller 800b causes the conveyance roller driver 806 to rotate the upstream conveyance roller pair 510 and the downstream conveyance roller pair 520b and causes the application roller driver 805 to rotate the application roller 604, thereby conveying the sheet P (S1005).

A description is given of the control of the temperature of the downstream conveyance roller pair 520a controlled in the above-described processing flow. For example, when the sheet P is the coated sheet and the application amount is large, the temperature of the lower roller 521b is controlled to be high. When the sheet P is the coated sheet and the application amount is normal, the temperature of the lower roller 521b is controlled to be low. When the sheet P is the plain sheet, or when the sheet P is the coated sheet and the application amount is small, the roller heater 528 is turned off so as to maintain the temperature of the lower roller 521b at a room temperature level.

As described above, when the sheet P is the “coated sheet” in the application device 500, the temperature of the lower roller 521b is set to be high in the case of the application amount “large” of the aggregation liquid 617 to accelerate evaporation of volatile components in the aggregation liquid 617 and keep the application surface of the sheet P stable. Thus, when the downstream conveyance roller pair 520 conveys the sheet P, an adverse effect on the application surface due to contact or rubbing between the sheet P and the downstream conveyance roller pair 520 can be prevented during conveyance.

In the case of the application amount “normal” of the aggregation liquid 617 even when the sheet type is the “coated sheet,” the surface temperature of the lower roller 521b is set to be low to accelerate the evaporation of volatile components in the aggregation liquid 617 and prevent the roller heater 528 from excessively heat the sheet P. As a result, an influence due to contact or rubbing between the sheet P and the conveyance roller pair can be suppressed, and damages to the sheet P due to heating can be prevented, thereby preventing the conveyance wrinkles or conveyance failure (jam).

In the case of the application amount “small” of the aggregation liquid 617 even when the sheet type is the “coated sheet,” or when the sheet type P is the “plain sheet,” the roller heater 528 is turned off. In this case, the contact or rubbing between the sheet P and the downstream conveyance roller pair 520b does not adversely affect a quality of the application surface even without heating the sheet P. Thus, the roller heater 528 is turned off, thereby preventing the conveyance wrinkle and the conveyance failure (jam) caused by damage to the sheet P due to heating.

In the present embodiment, the temperature of the roller heater 528 is controlled in three levels of “high,” “low,” and “room temperature (heater off).” However, the levels are not limited to the above example, and for example, the temperature may be controlled in three levels of “high,” “medium,” and “low.” Although the application amount is divided into three levels of “large,” “normal,” and “small,” the application amount may be divided into four or more levels.

Next, a description is given of the application device 500 according to a fourth embodiment of the present disclosure. The fourth embodiment is a combination of the second embodiment and the third embodiment. The main configuration is described in detail below. All of the conveyance roller pairs disposed downstream from the application roller 604 may have the same configuration as that of a downstream conveyance roller pair 520c described below.

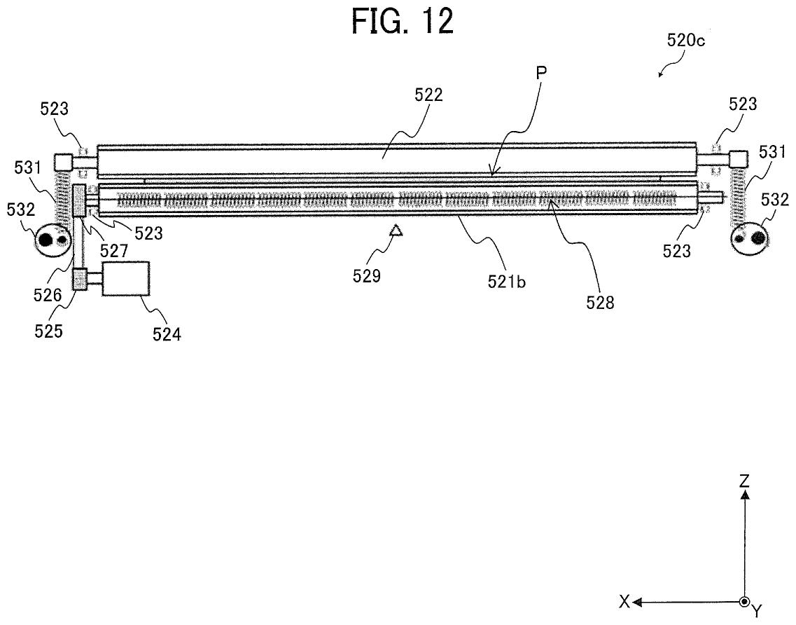

As illustrated in FIG. 12, the downstream conveyance roller pair 520c according to the fourth embodiment includes the tension springs 531 and the plate cams 532 at both ends of the upper roller 522, which are the same as the nip force applying member included in the downstream conveyance roller pair 520a according to the second embodiment. Similarly to the downstream conveyance roller pair 520b according to the third embodiment, the lower roller 521b includes the roller heater 528 inside thereof, and the temperature sensor 529 that measures the surface temperature of the lower roller 521b is provided.

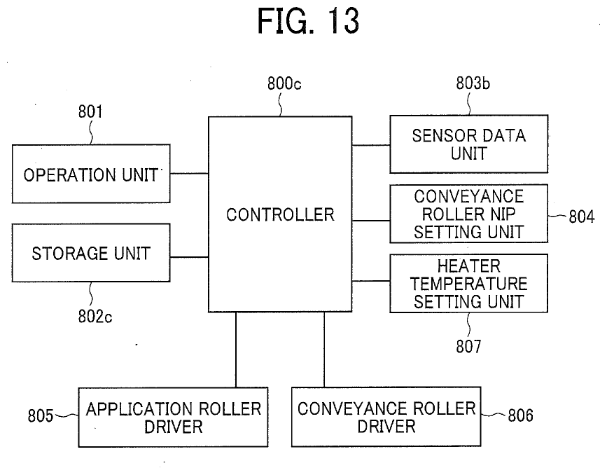

FIG. 13 is a block diagram illustrating a functional configuration of a control unit that controls the nip force and the temperature of the downstream conveyance roller pair 520c according to the present embodiment. The control unit according to the present embodiment includes a controller 800c, the operation unit 801, a storage unit 802c, the sensor data unit 803b, the conveyance roller nip setting unit 804, the application roller driver 805, the conveyance roller driver 806, and the heater temperature setting unit 807. The operation unit 801, the sensor data unit 803b, the conveyance roller nip setting unit 804, the application roller driver 805, the conveyance roller driver 806, the heater temperature setting unit 807 have the same configurations as those described above, and thus detailed descriptions thereof are omitted.

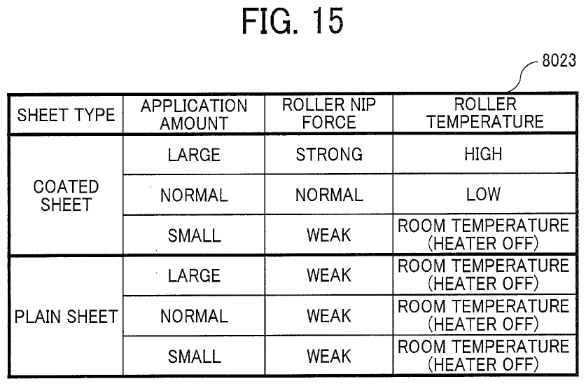

The storage unit 802c stores table data including the roller nip force data and the roller temperature setting data. In the table data, the roller nip force data and the roller temperature setting data are associated with the application amount to be set for each of the sheet characteristic data (e.g., sheet types). FIG. 15 illustrates a nip force and temperature setting table 8023 as an example of the table data stored in the storage unit 802c. The nip force and temperature setting table 8023 stores a correlation between the application amount, the roller nip force data, and the roller temperature setting data.

As illustrated in FIG. 15, the nip force and temperature setting table 8023 stores the roller nip force data to set the nip force and the roller temperature setting data to set the temperature of the roller heater 528 in association with the sheet type and the application amount of the aggregation liquid 617. A suitable application amount is measured in advance for each sheet type included in the sheet characteristic data, and the suitable application amount (the reference value of the appropriate application amount for the sheet type) corresponds to the application amount “normal.” An appropriate nip force corresponding to the application amount “normal” is defined as the roller nip force “normal.” The roller temperature suitable for the application amount “normal” is set based on the sheet type as a reference, and the other settings related to the application amount are determined based on the reference in advance.

When the user sets the sheet type to the “coated sheet” and sets the application amount of the aggregation liquid 617 to “large” with the operation unit 801, the plate cam 532 is rotated so that the downstream conveyance roller pair 520c applies the roller nip force corresponding to “strong.” The roller nip force “strong” is determined relative to the roller nip force “normal,” and the degree of “strong” may be determined based on a parameter defined in advance, or data for obtaining a force stronger than the roller nip force “normal” may be separately stored.

When the user sets the sheet type to the “coated sheet” and sets the application amount of the aggregation liquid 617 to “large,” the heater temperature setting unit 807 controls the temperature of the roller heater 528 so as to maintain the surface temperature of the lower roller 521b at the temperature corresponding to the roller temperature “high.”

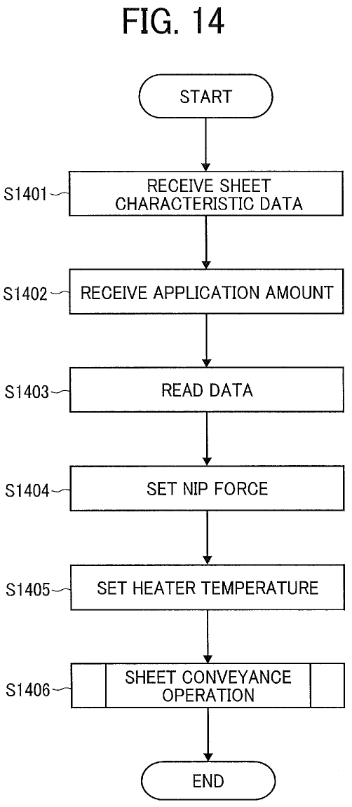

Next, a control flow in the controller 800c according to the present embodiment is described with reference to a flowchart in FIG. 14. First, a user of the application device 500 sets the “sheet type” with the operation unit 801 to designate the type of the sheet P. The controller 800c receives the “sheet type” from the operation unit 801 (S1401). Then, the user sets the “application amount” with the operation unit 801 to designate the amount of the aggregation liquid 617 to be applied to the sheet P. The controller 800c receives the “application amount” from the operation unit 801 (S1402). Subsequently, based on the “sheet type” and the “application amount” set by the user, the controller 800c reads the “roller nip force” and the “roller temperature” stored in the nip force and temperature setting table 8023 from the storage unit 802c (S1403).

Based on the “roller nip force,” the controller 800c instructs the conveyance roller nip setting unit 804 to set the nip force of the downstream conveyance roller pair 520c to a predetermined value. The conveyance roller nip setting unit 804 causes the plate cam 532 to rotate and stop at the position where the instructed nip force is obtained (S1404). The controller 800c controls the heater temperature setting unit 807 based on the “roller temperature” read from the storage unit 802 so that the surface temperature of the lower roller 521b becomes a predetermined temperature. The heater temperature setting unit 807 controls the duty of the roller heater 528 while referring to the output value of the sensor data unit 803b, and controls the surface temperature of the lower roller 521b (S1405). After that, the controller 800c causes the conveyance roller driver 806 to rotate the upstream conveyance roller pair 510 and the downstream conveyance roller pair 520c and causes the application roller driver 805 to rotate the application roller 604, thereby conveying the sheet P (S1406).

A description is given of the control of the nip force (roller nip force) and the temperature of the downstream conveyance roller pair 520c controlled in the above-described processing flow. For example, when the sheet P is the coated sheet, the aggregation liquid 617 is less likely to permeate into the sheet P, remains on the surface of the sheet P, and thus is more likely to be rubbed, thereby significantly affecting the change in the frictional resistance of the surface of the sheet P and also affecting the conveyance performance of the sheet P. When the application amount is set to “large,” the conveyance performance is affected particularly on the downstream side. Therefore, the roller nip force of the downstream conveyance roller pair 520c is set to “strong,” and the temperature of the lower roller 521b is set to be high. Even when the sheet type is the “coated sheet,” the roller nip force is set to “normal” and the surface temperature of the lower roller 521b is set to be low in the case of the application amount “normal” of the aggregation liquid 617. Here, the roller nip force “normal” is designated suitable for the application amount “normal” in advance.

As described above, the downstream conveyance roller pair 520c that is controlled based on the sheet type and the application amount of the aggregation liquid 617 can prevents the slip (speed unevenness) of the sheet P and thus prevents the application surface of the sheet P from being rubbed by the lower roller 521b, thereby suppressing the change in surface properties of the sheet P. As a result, image unevenness due to a difference in aggregation properties of the liquid ink due to the change in the surface properties can be prevented. In addition, the evaporation of the volatile component of the aggregation liquid 617 can be accelerated and the sheet P can be prevented from being excessively heated, thereby suppressing an influence due to contact or rubbing between the sheet P and the conveyance roller pair. Further, the sheet P is not damaged by heating, thereby preventing conveyance wrinkles and conveyance failure (jam).

Also in the present embodiment, the temperature of the roller heater 528 is controlled in three levels of “high,” “low,” and “room temperature (heater off).” However, the levels are not limited to the above example, and for example, the temperature may be controlled in three levels of “high,” “medium,” and “low.” Although the application amount is divided into three levels of “large,” “normal,” and “small,” the application amount may be divided into four or more levels.

According to the first embodiment of the present disclosure described above, the conveyor (i.e., the downstream conveyance roller pair) is in line contact with a medium (sheet P) to which the treatment liquid has been applied, not in point (partially) contact. Therefore, the application surface can be prevented from being partially rubbed by the conveyor, thereby preventing image unevenness. Further, the conveyance force that is applicable to high-speed image forming process can be secured at low cost.

According to the second embodiment, the nip force of the downstream conveyance pair can be changed to be suitable for the type of the sheet P and the application amount (application state) of the treatment liquid, thereby preventing the slip (speed unevenness) during conveyance of the sheet P. Accordingly, image unevenness can be prevented. In the case of the coated sheet and the application amount “large,” the nip force is set to “strong” to prevent the slip (speed unevenness) during conveyance, thereby preventing image unevenness. In the case of the coated sheet and the application amount “small,” and in the case of the plain sheet, the nip force is set to “weak” to prevent the grip between the application surface of the sheet P and the lower roller 521 from being excessively strong, thereby preventing the wrinkles of the sheet P caused by the roller shape.

According to the third embodiment, the downstream conveyance roller pair including the heater can apply suitable heat to the sheet medium to accelerate drying of the application surface, thereby preventing the sheet medium from deforming. Accordingly, image unevenness due to contact or rubbing between the sheet medium and the conveyance roller pair can be prevented.

According to the fourth embodiment, in the case of the coated sheet, the temperature of the roller heater 528 is set to be higher to heat the sheet P at a suitable temperature in response to the larger application amount and set to be lower to heat the sheet P at a suitable temperature in response to smaller application amount. With such a setting, the roller heater 528 does not excessively apply heat to the sheet medium, thereby preventing the sheet medium from deforming and wrinkling due to thermal damage to the sheet medium. As a result, the slip (speed unevenness) during conveyance can be prevented, thereby preventing image unevenness. In the case of the plain sheet, since the treatment liquid permeates into the sheet medium, and the change in the frictional force of the surface of the sheet medium is small. Therefore, the temperature of the roller heater 528 can be low (set to the “room temperature”), and the roller heater 528 does not excessively apply heat to the sheet medium, thereby preventing the sheet medium from deforming and wrinkling due to thermal damage to the sheet medium and from wrinkling caused by the roller shape.

As described above, according to the present disclosure, the sheet medium can be conveyed downstream while evenly maintaining the treatment liquid applied thereto.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

What is claimed is:

1. An application device comprising:
an application roller configured to apply a treatment liquid to a sheet medium; and
multiple conveyance roller pairs configured to convey the sheet medium from an upstream side to a downstream side of the application roller, the multiple conveyance roller pairs defining a conveyance path of the sheet medium and including a downstream conveyance roller pair adjacent to the application roller on the downstream side along the conveyance path,
wherein the downstream conveyance roller pair includes:
two rollers having a length equal to or longer than a width of the sheet medium; and
a nip force applying member configured to apply a nip force to one of the two rollers to nip the sheet medium with the two rollers in a width direction of the sheet medium.

2. The application device according to claim 1,
wherein the downstream conveyance roller pair further includes a nip force changer configured to change the nip force.

3. The application device according to claim 2,
wherein the nip force changer changes the nip force based on an application amount of the treatment liquid,
wherein the nip force changer sets the nip force to a first nip force in response to a first application amount of the treatment liquid and set the nip force to a second nip force in response to a second application amount of the treatment liquid, the first nip force being stronger than the second nip force, the first application amount being larger than the second application amount.

4. The application device according claim 1,
wherein one of the two rollers includes a heater configured to heat the sheet medium to which the treatment liquid is applied.

5. The application device according to claim 4,
wherein the heater changes a temperature of the one of the two rollers based on an application amount of the treatment liquid,
wherein the heater heats the one of the two rollers at a first temperature in response to a first application amount of the treatment liquid and heat the one of the two rollers at a second temperature in response to a second application amount of the treatment liquid, the first temperature being higher than the second temperature, the first application amount being larger than the second application amount.

6. The application device according to claim 2, further comprising:
an operation unit configured to receive input data to transmit a type of the sheet medium and an application amount of the treatment liquid; and
circuitry configured to cause the nip force applying member to change the nip force based on the type of the sheet medium and the application amount transmitted from the operation unit.

7. An image forming apparatus comprising:
an image forming device configured to apply a liquid to a sheet medium to form an image on the sheet medium; and
the application device according to claim 1, configured to apply the treatment liquid to the sheet medium on the upstream side of the image forming device,
wherein the multiple conveyance roller pairs are configured to convey the sheet medium to the image forming device.
